(19) United States
(12) Patent Application Publication
(10) Pub. No.: US 2026/0247145 A1
(43) Pub. Date: Aug. 20, 2026

(54) SYSTEMS AND METHODS FOR DETERMINING AND UPDATING END DEVICE DATA SECURITY PARAMETERS FOR REMOTE DATA TRANSMISSIONS

(71) Applicant: BANK OF AMERICA CORPORATION, Charlotte, NC (US)

(72) Inventors: Jinna Kim, Charlotte, NC (US); Christine D. Black, Brooksville, ME (US); Sanjay Lohar, Mint Hill, NC (US); Prem Obhan, Frisco, TX (US)

(73) Assignee: BANK OF AMERICA CORPORATION, Charlotte, NC (US)

(21) Appl. No.: 19/056,236

(22) Filed: Feb. 18, 2025

(51) Int. Cl. H04W 12/06

(52) U.S. Cl. CPC H04W 12/06

(57) ABSTRACT

Systems, computer program products, and methods are described herein for determining and updating end device data security parameters for remote data transmissions. The present invention is configured to identify a user account; validate a user device associated with the user account is configured to receive at least one potential recommendation; identify historical user data associated with the user account; determine, by an artificial intelligence (AI) engine, at least one third party data associated with the historical user data, wherein the AI engine is stored on the user device associated with the user account; determine, by the AI engine, at least one potential third party data for the user account; determine, by the AI engine, at least one potential recommendation associated with the at least one potential third party identifier; and trigger a configuration of a graphical user interface (GUI) of the user device with the at least one potential recommendation.

### FIELD OF THE INVENTION

The present invention embraces a system for determining and updating end device data security parameters for remote data transmissions.

### BACKGROUND

In today's electronic environment, protecting user data across networks and at end-devices is more important than ever. However, and importantly, is the user's ability to access certain functions of third parties that usually require their user data before allowing these functions to be accessed or shared. Thus, a system that can efficiently, dynamically, and securely determine and update end device data security parameters for remote data transmissions is needed.

Applicant has identified a number of deficiencies and problems associated with determining data security parameters at end-devices for different receiving entities. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for determining and updating end device data security parameters for remote data transmissions is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify a user account; identify historical user data associated with the user account; determine, by an artificial intelligence (AI) engine, at least one third party data associated with the historical user data, wherein the at least one third party data comprises historical recommendations presented to the user account, and wherein the AI engine is stored on a user device associated with the user account; determine, by the AI engine, at least one potential third party data for the user account, wherein the at least one potential third party data comprises at least one potential third party identifier; determine, by the AI engine, at least one potential recommendation associated with the at least one potential third party identifier; and trigger a configuration of a graphical user interface (GUI) of the user device with the at least one potential recommendation.

In some embodiments, executing the computer-readable code is further configured to cause the at least one processing device to: receive the at least one potential recommendation from at least one third party device; generate, by the user device, a recommendation interface component comprising the at least one potential recommendation; and automatically trigger the configuration of the GUI of the user device with the recommendation interface component. In some embodiments, executing the computer-readable code is further configured to cause the at least one processing device to: identify, by the user device, at least one acceptance at the recommendation interface component for the at least one potential recommendation; and automatically transmit, by the user device and based on the at least one acceptance, user identifying data to a third party entity associated with the at least one potential recommendation accepted. In some embodiments, executing the computer-readable code is further configured to cause the at least one processing device to: collect, by the AI engine, the at least one acceptance for the at least one potential recommendation; and input, in real time or near real time, the at least one acceptance to the AI engine, wherein the input of the at least one acceptance further trains the AI engine for the user account.

In some embodiments, the at least one potential recommendation is customized to a user of the user device, and wherein the at least one potential recommendation is determined by the AI engine based on historical user data comprising historical recommendations accepted by the user account. In some embodiments, the AI engine determines the at least one potential recommendation based on a shared entity type with at least one third party of the historical recommendation accepted, shared recommendation type with the historical recommendation accepted, or a shared geolocation with at least one third party of the historical recommendation accepted. In some embodiments, executing the computer-readable code is further configured to cause the at least one processing device to: generate a feedback interface component, wherein the feedback interface component comprises at least one feedback input for the user account; configure the GUI of the user device with the feedback interface component at a pre-determined interval; and receive, at the user device, a user input at the feedback interface component, wherein the user input comprises an indication of re-acceptance or disapproval of one or more historical recommendation accepted. In some embodiments, the pre-determined interval comprises a weekly interval, a bi-weekly interval, or a monthly interval.

In some embodiments, the AI engine transmits a request for the at least one potential recommendation to the at least one third party device, and wherein the request comprises non-user identifying data.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for generating an interactive 3D environment using spatial computing to generate historical digital components, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for determining and updating end device data security parameters for remote data transmissions, in accordance with an embodiment of the disclosure;

FIG. 4 illustrates a process flow for generating a recommendation interface component, identifying an acceptance at the recommendation interface component, and training the AI engine based on the acceptance, in accordance with an embodiment of the disclosure; and

FIG. 5 illustrates a process flow for generating a feedback interface component to receive feedback from a user, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same.

In today's electronic environment, protecting user data across networks and at end-devices is more important than ever. However, and importantly, is the user's ability to access certain functions of third parties that usually require their user data before allowing these functions to be accessed or shared. Thus, a system that can efficiently, dynamically, and securely determine and update end device data security parameters for remote data transmissions is needed.

Accordingly, the preset disclosure provides for the identification of a user account; the identification of historical user data associated with the user account; the determination, by an artificial intelligence (AI) engine, of at least one third party data associated with the historical user data, wherein the at least one third party data comprises historical recommendations presented to the user account, and wherein the AI engine is stored on a user device associated with the user account; the determination, by the AI engine, of at least one potential third party data for the user account, wherein the at least one potential third party data comprises at least one potential third party identifier; and the determination, by the AI engine, of at least one potential recommendation associated with the at least one potential third party identifier. Further, and based on the determined potential recommendation(s), the disclosure provides for the triggering of a configuration of a graphical user interface (GUI) of the user device with the at least one potential recommendation.

In other words, the disclosure comprises edge device artificial intelligence (AI) ending that gathers user data (such as offer history, which may include third parties the user has interacted with in the past, accepted offers from in the past, rejected offer from in the past, and/or the like) to identify associated third parties that the user may interact with at a future time. Importantly, and while gathering preferred third party information and their associated functions or offers, the AI engine may make these determinations of which third parties to present to the user without sharing any user data. Further, and based on at least the identification of these third parties, the AI engine may determine which potential offers to present to the user (which may be based on a number of factors, such as but not limited to geographic locations, historical offers accepted, historical offer types accepted or rejected, user data shared, and/or the like). Upon determining these potential offers, the system described herein may automatically reconfigure the user device's graphical user interface with the potential offers for the user to accept or reject, and upon accepting any of the potential offers, the AI engine may dynamically and automatically determine what user data is necessary to transmit or share with the associated third party entity that generated the accepted potential offer. Thus, the system described herein may improve data security within user devices and across networks, while also allowing for data to be shared from the entity to the user device without unnecessary delay or unnecessary filtering of potential offers.

What is more, the present invention provides a technical solution to a technical problem. As described herein, the technical problem includes determining data security parameters (e.g., which data to share and which data to filter from being shared or transmitted, at the end user device) at end-devices for different receiving entities. The technical solution presented herein allows for the automatic, efficient, secure, and dynamic determination and updating of end device data security parameters for remote data transmissions. In particular, the disclosure provided herein is an improvement over existing solutions to the these technical problems, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

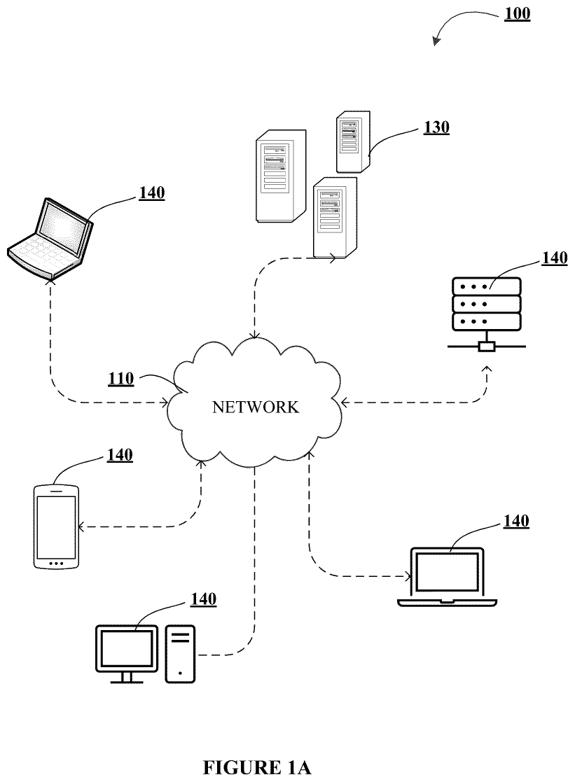

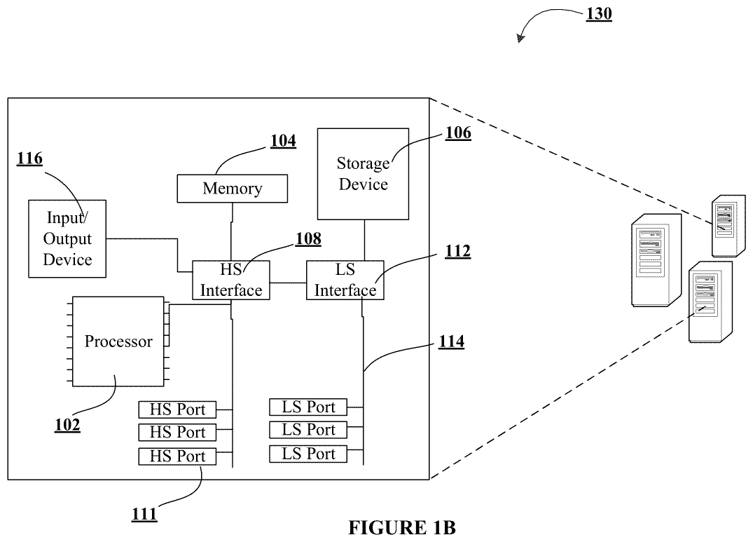

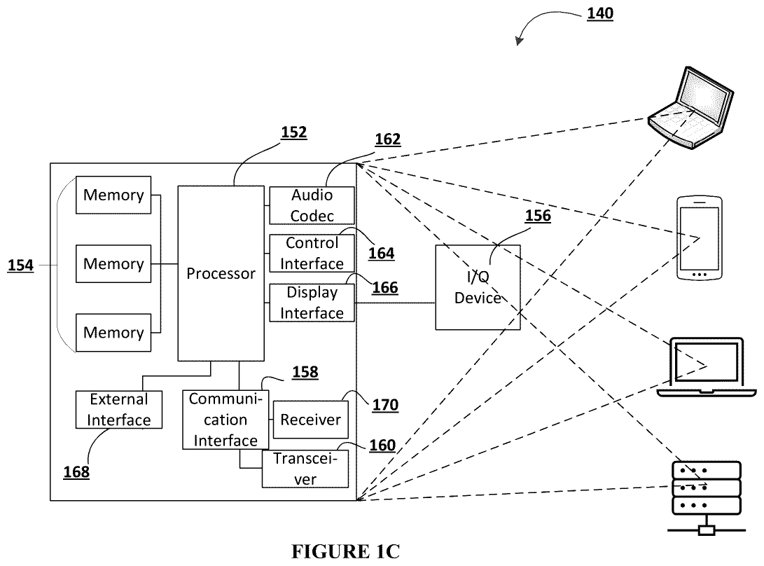

FIGS. 1A-1C illustrate technical components of an exemplary distributed computing environment for determining and updating end device data security parameters for remote data transmissions 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

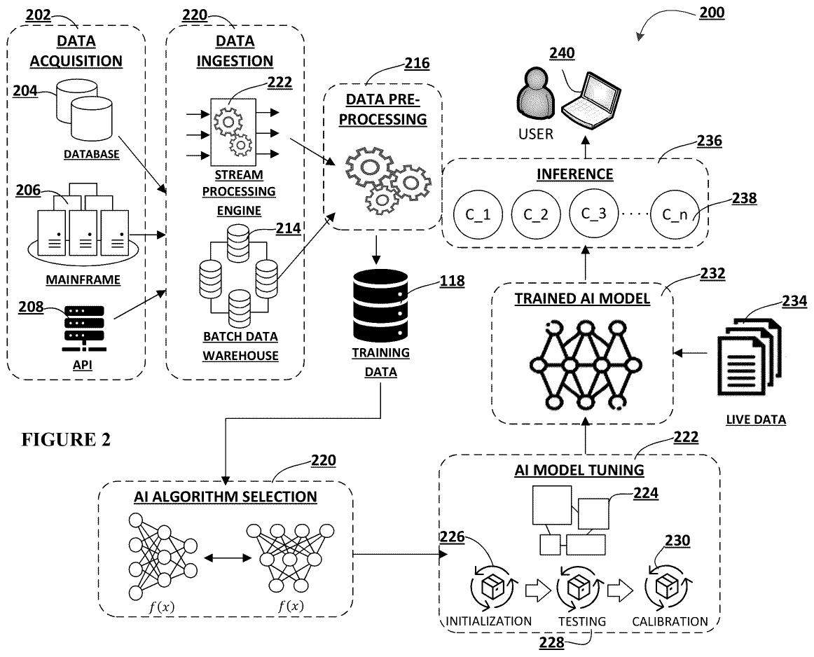

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

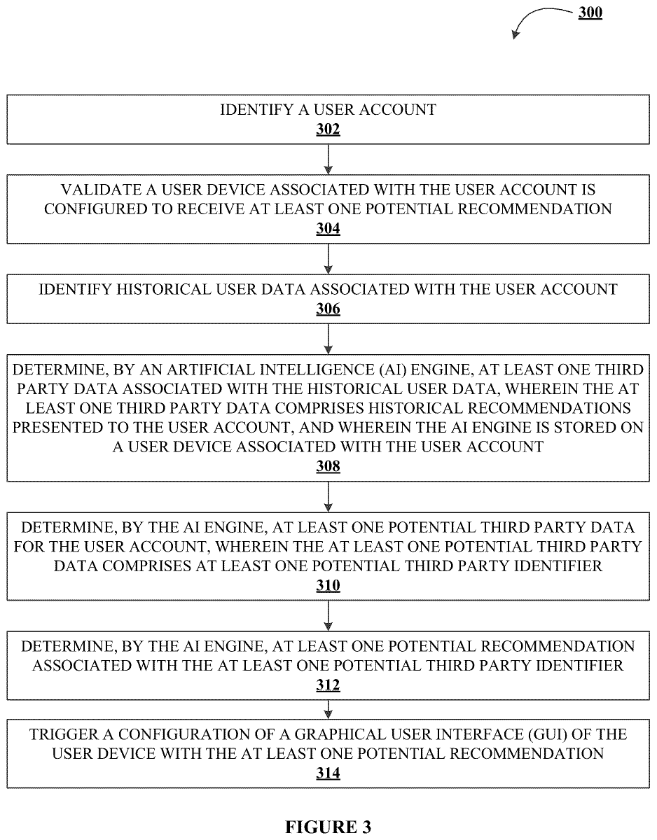

FIG. 3 illustrates a process flow 300 for determining and updating end device data security parameters for remote data transmissions, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some, or all, of the steps described in process flow 300.

As shown in block 302, the process flow 300 may include the step of identifying a user account. For example, the system may identify a user account associated with a user device, by identifying and validating authentication credentials from a user inputting their authentication credentials at the user device. In such an embodiment, the system may identify a user account based on the authentication credentials received and validated, and upon validating the user as the authenticated user of the user account, the system may collect the interactions by the user at the user device (e.g., mouse clicks, typing, selections of recommendations, and/or the like). For example, and in some such embodiments, the system may identify a user after a user has successfully logged in (e.g., via input of authentication credentials) at an application on the user device. In some such embodiments, the system may request a validation of the authentication credentials from a third party device/entity that operates the application at the user device. In some embodiments, the user account may be identified by a user inputting a pin or sequence of characters to unlock the user device, and based on the user correctly inputting is sequence of characters, the system may identify the user as an authenticated user of the user device.

As shown in block 304, the process flow 300 may include the step of validating a user device associated with the user account is configured to receive at least one potential recommendation. For instance, the system may automatically access the settings within the user device and/or the settings within the user account to determine if the user device and/or the user account can receive a potential recommendation. Such a potential recommendation, which is described in further detail below, may comprise data on offers of products, services, applications, devices, and/or the like transmitted from a third party entity or third party device to the user device. Thus, and in some embodiments, the system may perform a validation of the settings of the user device to determine an end-user device status, such as a status indicating the user device can receive data transmissions, can generate push notifications, and/or the like (e.g., is not in a do not disturb).

Additionally, and/or alternatively, the system may perform a validation of the geolocation settings for the user device and determine that there are not any current geolocation-related restrictions in place by the user, the user account, and/or by the user device itself. For example, the system may determine the current geolocation of the user device is not part of a restricted list of geolocations for the user device to receive data transmissions (e.g., potential recommendations), the system may determine the current geolocation of that sends the entity that sends the data transmissions (e.g., potential recommendations) is not part of a restricted list of geolocations of the user device, and/or the like.

Additionally, and/or alternatively, the system may validate the user device can receive one or more potential recommendations based on the user consent related to third party data transmissions. For example, and in some such embodiments, the system may determine the user of the user account has given consent based on at least one of a user device setting (e.g., a setting allowing third party data transmissions at the user device), user account setting (e.g., a setting allowing third party data transmissions for user devices that comprise the user account and/or are logged into the user account), third party setting for the specific user (e.g., based on a user account setting within the third party's system), and/or the like.

As shown in block 306, the process flow 300 may include the step of identifying historical user data associated with the user account. For instance, the system may identify and/or collect historical user data associated with the user account, such as but not limited to historical interaction data at the user device, historical recommendations accepted by the user, historical recommendations rejected by the user, historical recommendations accepted initially and later rejected by the user, application usage by the user, and/or the like.

As used herein, the terms “recommendation” and “recommendations” refers to an offering presented at the user device for at least one of a service, product, application, device, and/or the like from a third party entity. Thus, and as used herein, the term “recommendations accepted” refers to those recommendations that, at one point (e.g., historically, currently, and/or the like), were/are accepted by the user at the user device and/or at a related user device (which may be related based on an identification of the same user account as the user account identified at the instant user device). Similarly, the term “recommendation rejected) refers to recommendations, that, at one point (e.g., historically, currently, and/or the like), were/are rejected by the user at the user device and/or at a related user device. In some instances, and where a recommendation was both accepted and rejected at one point, the system may determine the recommendation was rejected when the recommendation was most recently rejected by the user (e.g., where the user may have initially accepted by the user) or the system may determine the recommendation was accepted when the recommendation was most recently accepted (e.g., where the user may have initially rejected the recommendation, but has since accepted the recommendation at a most recent time).

In some such embodiments, the system may identify the historical user data associated with the user account based on the user device itself collecting the interactions at the user device, such as but not limited to the acceptances, rejections, and/or the like of recommendations presented to the user. In some such embodiments, the system may identify each of the potential recommendations presented to the user, and the system may further identify the interactions by the user at the graphical user interface as the user interacts with each potential recommendation. For instance, and where a user ignores a potential recommendation as the user is scrolling through all the potential recommendations, the system (e.g., the user device operatively coupled to the user device) may collect the interactions surrounding the potential recommendations and may consider the ignoring of a potential recommendation as a rejection.

As shown in block 308, the process flow 300 may include the step of determining, by an artificial intelligence (AI) engine, at least one third party data associated with the historical user data, wherein the at least one third party data comprises historical recommendations presented to the user account, and wherein the AI engine is stored on a user device associated with the user account. For example, the system may determine—using a trained AI engine—at least one third party data associated with the historical user data, whereby the third party data may comprise third party identifiers that generated the recommendations accepted or rejected by the user historically. For example, and where a recommendation generated by third party entity A was previously rejected by the user, then the AI engine may identify the third party A as part of the third party data for at least one recommendation of the historical data. As used herein, the phrase “third party” or “third party entity” refers to a company, entity, individual, and/or the like, that provides offers or recommendations for products, services, applications, devices, and/or the like to a user at a user device/end device. Thus, and by way of non-limiting example, a third party entity may comprise a health care entity, non-profit, arts/entertainment company or entity, financial services company, agriculture companies, manufacturing and construction companies, hospitality companies and services, information services, and/or the like.

Further, the system—using the AI engine—may determine each of the third party identifiers for each of the recommendations historically accepted (and in some embodiments, rejected) by the user as part of the third party data. Additionally, and in some embodiments, the third party data may further comprise data of each historical recommendation accepted (and in some embodiments, rejected recommendations as well). For example, and in some such embodiments, the data of each recommendation may comprise, but is not limited to, recommendation type (e.g., an offer for services, type of service, offer for product, product type, offer for an application, application type, offer for a device, type of device, and/or the like), a geographic location of the recommendation (whether the recommendation is local to the user, within the same state as the user, within 20 miles of the user, national recommendation, international recommendation, and/or the like), a time period for the recommendation (e.g., a recommendation that is valid for 1 day, 7 days, 30 days/a month, unlimited time, and/or the like), and/or the like.

Additionally, and as discussed herein, an AI engine may be stored and operated within the user's user device. Thus, and in some such embodiments, the AI engine may be an end-device AI engine, and may be trained specific to the authenticated user(s) of the user device, such that the AI engine may determine customized potential recommendations to present to the user, such that the potential recommendations are more likely to be accepted by the user and in an instance where the potential recommendations are not accepted, the user device will prevent user data from being transmitted to any unauthorized third parties before the user has allowed the sharing of their user data. Thus, and as described herein, the disclosure provided herein may allow for greater data security for the users at their user devices, while also allowing for automatic and efficient determination of customized recommendations for the user to reject or accept.

Thus, the AI engine described herein, may be trained on historical recommendations presented to a user, which may have been accepted or rejected, historical data transmitted from the user device (or related user devices) to third party entities or devices, and/or the like. For instance, the AI engine may be trained with historical data transmitted from the user device (such as over a network) to determine what data the user approves for transmission and to what third party entities. Such data transmission information may then be used to train the AI engine to determine what the user considers as absolute protected user data (and may never allow transmission of), what the user considers as semi-protected user data (e.g., user data that may be transmitted and shared but only in limited circumstances and/or to limited third parties), and what the user considers as unprotected user data (e.g., user data that can be transmitted and shared in most or all circumstances, such as non-personal or non-user identifying data such as an a user device identifier, IIED identifier, IMEI number, IP address, and/or the like to identify the recipient device for a potential recommendation from a third party entity).

As shown in block 310, the process flow 300 may include the step of determining, by the AI engine, at least one potential third party data for the user account, wherein the at least one potential third party data comprises at least one potential third party identifier. For instance, the system may determine at least one potential third party identifier for a third party that has already been interacted with by the user of the user device (e.g., a third party identifier that is associated with a historical recommendation that was accepted), or a new third party that shares similar attributes with a third party that has already been interacted with. By way of non-limiting example, a user may have accepted a recommendation from third party A which may be an entity that creates applications for email services, then the AI engine may determine a potential third party B may generate a recommendation that would likely be accepted when the potential third party B creates applications for phone services. Thus, and by way of this example, both third party A and potential third party B are application as a service companies for office services, and therefore, share the one of the same recommendation types (e.g., office services as an entity type and/or application service applications as a product type).

Thus, and based on the pre-training of the AI engine with the historical user data, the AI engine and the system described herein may determine at least one potential third party data that is customized for the user account, whereby the potential third party data may comprise the same or similar third parties as previously accepted by the user account (e.g., via the acceptance of the historical recommendations). Thus, and in other words, the AI engine may determine the potential third party identifiers for the user account as the same third party identifier as a third party that was already opted into by the user account, a different third party identifier that has not been opted into before but comprises the same or similar offers, products, services, applications, devices, entity types, and/or the like.

As shown in block 312, the process flow 300 may include the step of determining, by the AI engine, at least one potential recommendation associated with the at least one potential third party identifier. For instance, the system may determine—using the trained AI engine—at least one potential recommendation associated with the third party identifier identified in block 308. For example, the AI engine may determine or filter, from a plurality of recommendations currently available from one or more potential third parties, which potential recommendations to present to the user of the user account. Thus, and in some such embodiments, the user device may transmit a request for a plurality of current recommendations to one or more potential third parties over a network (such as network 110 of FIG. 1A). Such a request may comprise non-user identifying data (such as an identifier that uniquely identifies the recipient user device that will receive the recommendations from the potential third parties). Upon receiving the request, the one or more potential third parties may transmit their current recommendations back to the user devices, and in response to receiving these recommendations, the AI engine may filter out the recommendations that will likely not be accepted by the user. Thus, and by filtering out these recommendations, the AI engine may determine the potential recommendations to present to the user. Therefore, and in other words, the at least one potential recommendation is customized to a user of the user device, and the at least one potential recommendation is determined by the AI engine based on historical user data comprising historical recommendations accepted by the user account.

In some embodiments, the AI engine may determine which of the recommendations that will likely not be accepted by the user based on one or more factors, such as the time of the recommendation (e.g., if the period for the recommendation's validity is shorter than most or all of the historical recommendations accepted by the user), the recommendation type (e.g., if the recommendation type is dissimilar to any of the historical recommendations accepted by the user), the user data that will have to be transmitted and shared from the user device in an instance where the recommendation is accepted (e.g., where the user data that will be shared after a user opts into/accepts the recommendation is allowed to be shared by the user with the third party associated with the recommendation), the geolocation of the recommendation (e.g., where the recommendation is limited to a geolocation where the user has never been and/or has never accepted a recommendation for), and/or the like. Thus, and in other words, the AI engine may determine the at least one potential recommendation based on a shared entity type with at least one third party of the historical recommendation accepted, shared recommendation type with the historical recommendation accepted, or a shared geolocation with at least one third party of the historical recommendation accepted.

As shown in block 314, the process flow 300 may include the step of triggering a configuration of a graphical user interface (GUI) of the user device with the at least one potential recommendation. For instance, the system within the user device may automatically generate an interface component comprising data of each potential recommendation determined by the AI engine in a computer-readable format, whereby the data in the computer-readable format may automatically configure the GUI of the user device upon generation. Based on the data of each potential recommendation in the interface component, the user device may automatically render the potential recommendations on the GUI of the user device in a human-readable format.

In some embodiments, the AI engine may be trained to generate the interface component. In some such embodiments, the AI engine may generate the interface component with a specified hierarchy or organization of potential recommendations, such as but not limited to organizing the potential recommendations that are determined to be the most likely to be accepted at the very top of the interface component (e.g., shown first on the GUI). In some embodiments, the AI engine may be configured to update the interface component generated by the system, to change the placement of the potential recommendations such that the rendering of the potential recommendations on the GUI are in a position to be seen first by the user (e.g., shown first or at the top of the GUI within the interface component rendering).

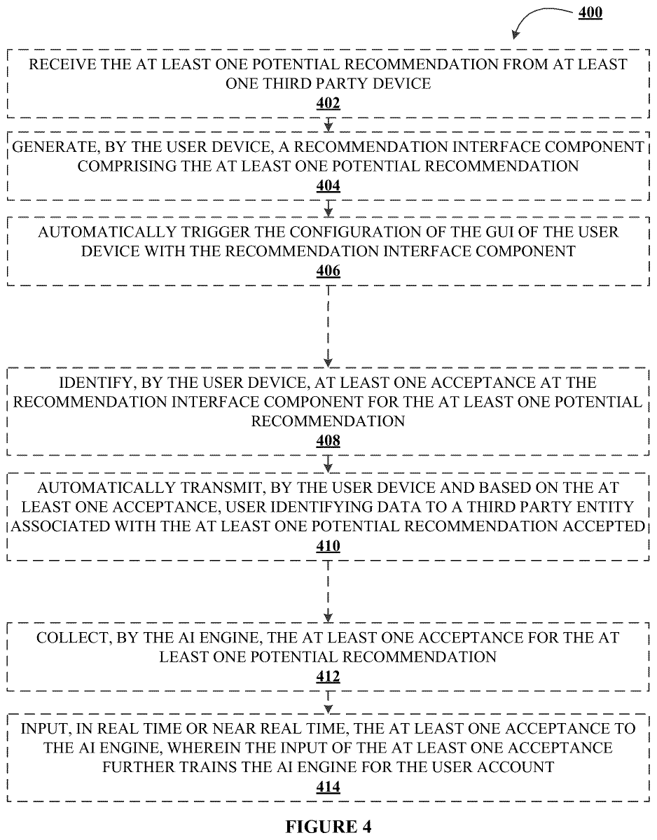

FIG. 4 illustrates a process flow 400 for generating a recommendation interface component, identifying an acceptance at the recommendation interface component, and training the AI engine based on the acceptance, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some, or all, of the steps described in process flow 400.

In some embodiments, and as shown in block 402, the process flow 400 may include the step of receiving the at least one potential recommendation from at least one third party device. For example, and in some such embodiments, the system may receive the data of the potential recommendation(s) from one or more third party entities/devices, where the data may comprise information on a product, service, application, device, time period, geolocation, third party identifier, and/or the like from the third party entity/device. In some such embodiments, the data of the potential recommendation may be used by the AI engine to automatically filter out potential recommendations received that will not likely be accepted by the user. Thus, and as used herein, the terms “filter” or “filtering” refers to blocking the potential recommendation from further processing within the user device, automatically deleting the data of the potential recommendation, and/or transmitting the potential recommendation back to the sending third party entity/device. Thus, and in other words, by filtering the potential recommendations, the AI engine blocks these filtered potential recommendations from further access at the user device. In some embodiments, the analysis by the AI engine may occur within a container on the user device, and upon filtering out the potential recommendations within the container, the AI engine may only allow the allowed potential recommendations (i.e., non-filtered out potential recommendations) to leave the container and be processed further by the system described herein (e.g., for generating an interface component to configure the GUI of the user device).

In some embodiments, and as shown in block 404, the process flow 400 may include the step of generating, by the user device, a recommendation interface component comprising the at least one potential recommendation. For example, the system may generate a recommendation interface component comprising one or more potential recommendations and the associated data for each of the potential recommendations. Thus, the system (and/or the AI engine) may generate this recommendation interface component locally and at the user device.

In some embodiments, the recommendation interface component may comprise all the potential recommendations determined by the AI engine, such that the user of the user device may accept or reject each potential recommendation. In some embodiments, and as described briefly above, the recommendation interface component may be generated wholly or in part by the AI engine, updated by the AI engine, and/or the like. In some such embodiments, the AI engine may dynamically update and reconfigure the rendering of potential recommendations to show an optimized rendering of all the potential recommendations, such as but not limited to a rendering showing the most likely to be accepted potential recommendations first. Such an updating of the recommendation interface component rendering may be based on historical user data collected by the system and used to train the AI engine.

In some embodiments, and as shown in block 406, the process flow 400 may include the step of automatically triggering the configuration of the GUI of the user device with the recommendation interface component. For example, and in some such embodiments, the system (or AI engine) may automatically trigger the configuration of the GUI of the user device upon generating the recommendation interface component. In some embodiments, and where the AI engine is configured to update the recommendation interface component, the system may transmit the trigger to the user device with computer-readable instructions to configure the GUI after the AI engine has processed the recommendation interface component and output an updated recommendation interface component. Thus, and as described briefly above, the recommendation interface component (or updated recommendation interface component) may be generated with the data of the potential recommendations in a computer-readable format which may comprise instructions for the user device to automatically configure its GUI. Based on the data of each potential recommendation, the user device may automatically render each potential recommendation in human-readable format.

In some embodiments, and as shown in block 408, the process flow 400 may include the step of identifying, by the user device, at least one acceptance at the recommendation interface component for the at least one potential recommendation. For example, and in some such embodiments, the system may identify at least one acceptance or at least one rejection at the recommendation interface component by the system collecting interaction data of the user at the user device. Such interaction data may comprise mouse clicks, keyboard entries, touchscreen inputs, selectable icon inputs, and/or the like. In some embodiments, an acceptance may be identified by the user “clicking” (at a selectable icon) an indicator on the recommendation interface component showing an “opt in” option or “accept” option. In some embodiments, a rejection may be identified by the user ignoring the potential recommendation (e.g., not interacting with the potential recommendation during the time the recommendation interface component is rendered on the GUI; interacting with the potential recommendation, but not selecting “accept” or “reject” at the recommendation interface component; and/or the like), or by the user “clicking” an indicator on the recommendation interface component showing an “opt out” option or “reject” option.

Thus, and in some such embodiments, the system may collect each of these interactions to determine which potential recommendations rendered in the recommendation interface component are accepted or rejected.

In some embodiments, and as shown in block 410, the process flow 400 may include the step of automatically transmitting, by the user device and based on the at least one acceptance, user identifying data to a third party entity associated with the at least one potential recommendation accepted. For example, and in some such embodiments, the system (via the user device and over a network) may automatically transmit the user identifying data that is required to complete the accepted potential recommendation(s). Thus, and in other words, each potential recommendation may require different user identifying data in order to fully opt in or fully accept the potential recommendation, and based on which potential recommendation(s) accepted by the user, the system (via the user device) may automatically and dynamically determine which user identifying data to transmit from the user device and to which third party device (i.e., the third party device associated with the third party entity that generated the accepted potential recommendation). Thus, and importantly, the system described herein may protect any user-identifying data from being transmitted or shared outside of the user device until the user has allowed the sharing of the user data.

As used herein, the term “user identifying data” refers to any identifying data that may partially or fully identify the user of the user account (e.g., name, address, phone number, work address, social security number, bank information, and/or the like). Therefore, and in such embodiments, only the user identifying data that is determined to be necessary for sharing with the third party entity will be transmitted or shared. Thus, the AI engine may, itself, dynamically and automatically filter the available user data within the user device, and/or stored within applications on the user device, and determine the appropriate or necessary data to send to the third party entity/device. Thus, and in some embodiments, more data than is necessary may be stopped from being shared, and user data may be kept secure from transmissions as much as possible. Therefore, such user identifying data may further be filtered or selected by the system (and/or by the AI engine of the system) and based on the accepted potential recommendation before transmission, which allows for greater information and data security in an automated, dynamic, and secure manner.

In some embodiments, and as shown in block 412, the process flow 400 may include the step of collecting, by the AI engine, the at least one acceptance for the at least one potential recommendation. For instance, as described above, the system or the AI engine may collect at least one acceptance or at least one rejection from the recommendation interface component. In some embodiments, the AI engine may use this collected acceptance and rejection data to automatically and in real time or near real time retrain/refine itself for future determinations of potential recommendations to present to the same user.

In some embodiments, and as shown in block 414 the process flow 400 may include the step of inputting, in real time or near real time, the at least one acceptance to the AI engine, wherein the input of the at least one acceptance further trains the AI engine for the user account. Thus, and in some such embodiments, the AI engine may continuously refine and train itself with the data collected and interactions at each potential recommendation at the user device. Thus, and in some such embodiments, the AI engine described herein continually trains and refines itself based on individual user data to determine, filter, and adjust/update potential recommendations to present to the user at the user device, while also protecting user data from unnecessary data sharing.

Additionally, and/or alternatively, the AI engine may further be trained on group user data for users in the same or similar recommendations accepted or rejected. Thus, and in some embodiments, and without sharing user identifying data, the AI engine at the user device may communicate with other AI engines at other user devices to share what potential recommendations were accepted and rejected in order to further train and refine itself. In some such embodiments, the communication between these AI engines may be limited based on near field technology, such that the AI engine will not share user identifying data, but will be able to identify user devices that share at least similar geographic locations visited by other users (e.g., users that visit the same store, same work, and/or the like).

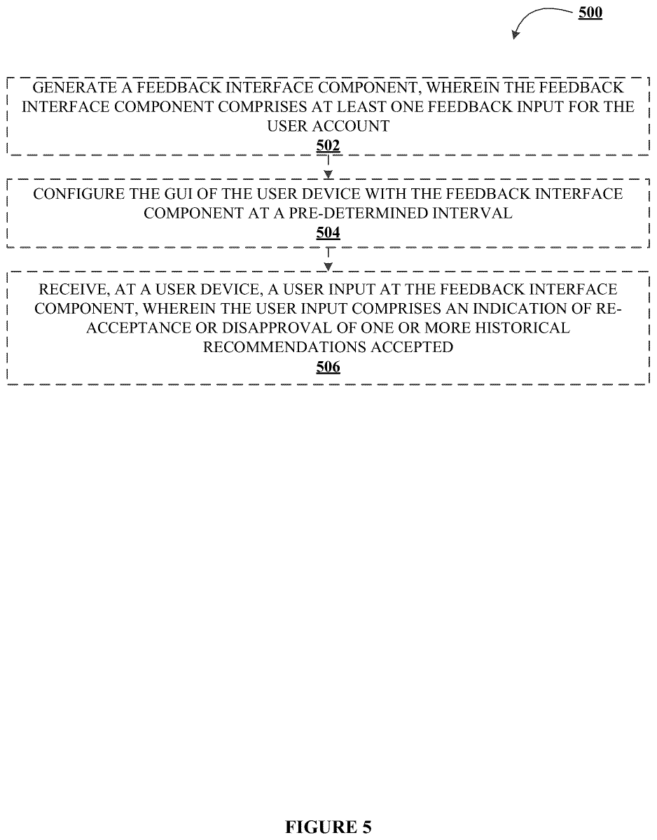

In some embodiments, the system may further refine the AI engine at every instance an acceptance or rejection is detected from the user of the user account. Thus, and in real time or near real time as an acceptance or rejection is identified at the interface component (or recommendation interface component), the AI engine may continuously refine itself using real time input and processing of these acceptances and rejections. Additionally, and in some embodiments, the AI engine may further refine itself with intermittent feedback from users, which is further described below with respect to FIG. 5.

As understood by a person of skill in the art, each of the blocks herein described may occur as a standalone process, or as an ordered combination in the ordered combination shown and described herein, and/or as any ordered combination of blocks shown and described. By way of non-limiting example, the processes described with respect to blocks 402-406 may occur on their own within the system described herein, the processes described with respect to blocks 408-410 may occur on their own within the system described herein, and/or the processes described with respect to 412-414 may occur on their own within the system described herein.

FIG. 5 illustrates a process flow 500 for generating a feedback interface component to receive feedback from a user, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of generating a feedback interface component, wherein the feedback interface component comprises at least one feedback input for the user account. For instance, such a feedback interface component may be generated and rendered in a similar manner to the interface component and recommendation interface component described above. For example, and in some such embodiments, the feedback interface component may be generated and configured to render the past recommendations accepted by the user, and may further comprise a selectable icon requesting the user to “accept” or “re-opt in” to the past recommendation, and/or a selectable icon requesting the user to “reject” or “opt out” of the past recommendation. By way of example, the feedback interface component may comprise each of the previously accepted/historically accepted recommendations, and at least one indicator or selectable icon requesting input by the user to show if the user still accepts the recommendation or now rejects the recommendation.

In some embodiments, the AI engine may configure the feedback interface component to show those historical recommendations that were accepted the longest time before the current time first, and which have not been recently re-accepted using a historical or previous feedback interface component. In some embodiments, the AI engine may configure the feedback interface component to show those historical recommendations that were accepted, but based on current user inputs for other similar potential recommendations, the AI engine determines the user is likely to now reject a historical recommendation of the same recommendation type and/or from the same third party entity as now the rejected potential recommendation. In such embodiments, the AI engine may configure the GUI with these historical recommendations first to render to the user on their user device. In some embodiments, the AI engine may be configured to only show a percentage of the historical recommendations accepted (such as a percentage of the historical recommendations that are now likely to be rejected, a percentage of the oldest historical recommendations accepted, and/or the like). Thus, and in such an embodiment, computing resources used in generating the feedback interface component and rendering the feedback interface component may be conserved.

In some embodiments, and as shown in block 504, the process flow 500 may include the step of configuring the GUI of the user device with the feedback interface component at a pre-determined interval. For example, and in some such embodiments, the system may configure the GUI of the user device with the feedback interface component in the same manner the system configured the GUI with the recommendation interface component or the recommendation interface component. In some embodiments, the feedback interface component may be automatically generated and configured on the user device's GUI at a regular and pre-defined interval. Such a pre-defined interval may comprise weekly, bi-weekly, monthly, bi-annually, yearly, and/or the like. Thus, and in an embodiment where the pre-defined interval is weekly, then the system may generate the feedback interface component the same day of the week, every week, and the system may automatically configure the GUI of the user device upon the full generation of the feedback interface component. In this manner, the user of the user account may regularly update their acceptances and rejections, and keep the AI engine up-to-date on the user's preferences for potential recommendations.

In some embodiments, and as shown in block 506, the process flow 500 may include the step of receiving, at a user device, a user input at the feedback interface component, wherein the user input comprises an indication of re-acceptance or disapproval of one or more historical recommendations accepted. For instance, and in some such embodiments, the system may receive and/or collect, the user input at the feedback interface component, which may indicate whether the user re-accepts or now rejects the historical recommendations presented at the feedback interface component. For example, and similar to the acceptance or rejection at the recommendation interface component, the system—based on collecting the interactions at the user device—may identify the acceptances and/or rejections of the historical recommendations and use such re-acceptances to continue to transmit or share user data with the associated third party entity or use such rejections to stop or halt any future transmissions of user data with the associated third party for the newly rejected recommendation. Additionally, and in some such embodiments, the inputs received at the feedback interface component may be used to continually retrain and refine the AI engine for future determinations of potential recommendations to present to the user and/or what data is acceptable to be shared with third parties.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for determining and updating end device data security parameters for remote data transmissions, the system comprising:
a memory device with computer-readable program code stored thereon;
at least one processing device operatively coupled to the memory device and at least one communication device, wherein executing the computer-readable code is configured to cause the at least one processing device to:
identify a user account;
validate a user device associated with the user account is configured to receive at least one potential recommendation;
identify historical user data associated with the user account;
determine, by an artificial intelligence (AI) engine, at least one third party data associated with the historical user data, wherein the at least one third party data comprises historical recommendations presented to the user account, and wherein the AI engine is stored on the user device associated with the user account;
determine, by the AI engine, at least one potential third party data for the user account, wherein the at least one potential third party data comprises at least one potential third party identifier;
determine, by the AI engine, the at least one potential recommendation associated with the at least one potential third party identifier; and
trigger a configuration of a graphical user interface (GUI) of the user device with the at least one potential recommendation.

2. The system of claim 1, wherein executing the computer-readable code is further configured to cause the at least one processing device to:
receive the at least one potential recommendation from at least one third party device;
generate, by the user device, a recommendation interface component comprising the at least one potential recommendation; and
automatically trigger the configuration of the GUI of the user device with the recommendation interface component.

3. The system of claim 2, wherein executing the computer-readable code is further configured to cause the at least one processing device to:
identify, by the user device, at least one acceptance at the recommendation interface component for the at least one potential recommendation; and
automatically transmit, by the user device and based on the at least one acceptance, user identifying data to a third party entity associated with the at least one potential recommendation accepted.

4. The system of claim 3, wherein executing the computer-readable code is further configured to cause the at least one processing device to:
collect, by the AI engine, the at least one acceptance for the at least one potential recommendation; and
input, in real time or near real time, the at least one acceptance to the AI engine, wherein the input of the at least one acceptance further trains the AI engine for the user account.

5. The system of claim 1, wherein the at least one potential recommendation is customized to a user of the user device, and wherein the at least one potential recommendation is determined by the AI engine based on historical user data comprising historical recommendations accepted by the user account.

6. The system of claim 5, wherein the AI engine determines the at least one potential recommendation based on a shared entity type with at least one third party of the historical recommendation accepted, shared recommendation type with the historical recommendation accepted, or a shared geolocation with at least one third party of the historical recommendation accepted.

7. The system of claim 5, wherein executing the computer-readable code is further configured to cause the at least one processing device to:
generate a feedback interface component, wherein the feedback interface component comprises at least one feedback input for the user account;
configure the GUI of the user device with the feedback interface component at a pre-determined interval; and
receive, at the user device, a user input at the feedback interface component, wherein the user input comprises an indication of re-acceptance or disapproval of one or more historical recommendation accepted.

8. The system of claim 6, wherein the pre-determined interval comprises a weekly interval, a bi-weekly interval, or a monthly interval.

9. The system of claim 1, wherein the AI engine transmits a request for the at least one potential recommendation to the at least one third party device, and wherein the request comprises non-user identifying data.

10. A computer program product for determining and updating end device data security parameters for remote data transmissions, wherein the computer program product comprises at least one non-transitory computer-readable medium having computer-readable program code portions embodied therein, the computer-readable program code portions which when executed by a processing device are configured to cause the processor to:
identify a user account;
validate a user device associated with the user account is configured to receive at least one potential recommendation;
identify historical user data associated with the user account;
determine, by an artificial intelligence (AI) engine, at least one third party data associated with the historical user data, wherein the at least one third party data comprises historical recommendations presented to the user account, and wherein the AI engine is stored on the user device associated with the user account;
determine, by the AI engine, at least one potential third party data for the user account, wherein the at least one potential third party data comprises at least one potential third party identifier;
determine, by the AI engine, the at least one potential recommendation associated with the at least one potential third party identifier; and
trigger a configuration of a graphical user interface (GUI) of the user device with the at least one potential recommendation.

11. The computer program product of claim 10, wherein the computer-readable program code portions which when executed by the processing device are configured to cause the processor to:
receive the at least one potential recommendation from at least one third party device;
generate, by the user device, a recommendation interface component comprising the at least one potential recommendation; and
automatically trigger the configuration of the GUI of the user device with the recommendation interface component.

12. The computer program product of claim 11, wherein the computer-readable program code portions which when executed by the processing device are configured to cause the processor to:
identify, by the user device, at least one acceptance at the recommendation interface component for the at least one potential recommendation; and
automatically transmit, by the user device and based on the at least one acceptance, user identifying data to a third party entity associated with the at least one potential recommendation accepted.

13. The computer program product of claim 10, wherein the at least one potential recommendation is customized to a user of the user device, and wherein the at least one potential recommendation is determined by the AI engine based on historical user data comprising historical recommendations accepted by the user account.

14. The computer program product of claim 13, wherein the AI engine determines the at least one potential recommendation based on a shared entity type with at least one third party of the historical recommendation accepted, shared recommendation type with the historical recommendation accepted, or a shared geolocation with at least one third party of the historical recommendation accepted.

15. The computer program product of claim 10, wherein the AI engine transmits a request for the at least one potential recommendation to the at least one third party device, and wherein the request comprises non-user identifying data.

16. A computer implemented method for determining and updating end device data security parameters for remote data transmissions, the computer implemented method comprising:
identifying a user account;
validating a user device associated with the user account is configured to receive at least one potential recommendation;
identifying historical user data associated with the user account;
determining, by an artificial intelligence (AI) engine, at least one third party data associated with the historical user data, wherein the at least one third party data comprises historical recommendations presented to the user account, and wherein the AI engine is stored on the user device associated with the user account;
determining, by the AI engine, at least one potential third party data for the user account, wherein the at least one potential third party data comprises at least one potential third party identifier;
determining, by the AI engine, the at least one potential recommendation associated with the at least one potential third party identifier; and
triggering a configuration of a graphical user interface (GUI) of the user device with the at least one potential recommendation.

17. The computer implemented method of claim 16, further comprising:
receiving the at least one potential recommendation from at least one third party device;
generating, by the user device, a recommendation interface component comprising the at least one potential recommendation; and
automatically triggering the configuration of the GUI of the user device with the recommendation interface component.

18. The computer implemented method of claim 17, further comprising:
identifying, by the user device, at least one acceptance at the recommendation interface component for the at least one potential recommendation; and
automatically transmitting, by the user device and based on the at least one acceptance, user identifying data to a third party entity associated with the at least one potential recommendation accepted.

19. The computer implemented method of claim 16, wherein the at least one potential recommendation is customized to a user of the user device, and wherein the at least one potential recommendation is determined by the AI engine based on historical user data comprising historical recommendations accepted by the user account.

20. The computer implemented method of claim 16, wherein the AI engine transmits a request for the at least one potential recommendation to the at least one third party device, and wherein the request comprises non-user identifying data.
